(19) United States
(12) Patent Application Publication
(10) Pub. No.: US 2011/0017221 A1
(43) Pub. Date: Jan. 27, 2011

(54) Methods and Apparatus for Reduction of Cortisol

(76) Inventors: Dena Petty Garner, Isle of Palms, SC (US); Mark Allen Roettger, Lake Elmo, MN (US); Henry Daniel Cross, Murrells Inlet, SC (US); Paul Anthony Broadbent, Mill Valley, CA (US)

Correspondence Address: Clise, Billion & Cyr, P.A., 605 U.S. Highway 169, Suite 300, Plymouth, MN, 55441, US

(21) Appl. No.: 12/686,960

(22) Filed: Jan. 13, 2010

Related U.S. Application Data
(63) Continuation of application No. PCT/US2008/070020, filed on Jul. 14, 2008.
Application No. PCT/US2008/070020 is a continuation-in-part of application No. 12/571,184, filed on Sep. 30, 2009.
Application No. 12/571,184 is a continuation-in-part of application No. 10/460,886, filed on Jun. 12, 2003.
Application No. 10/460,886 is a continuation-in-part of application No. 09/657,421, filed on Sep. 8, 2000, now Pat. No. 6,626,180.
Application No. 09/657,421 is a continuation-in-part of application No. 12/484,216, filed on Aug. 26, 2009.
Application No. 12/484,216 is a continuation of application No. PCT/US2009/047295, filed on Jun. 14, 2009.
Application No. 12/484,216 is a continuation-in-part of application No. 10/460,886, filed on Jun. 12, 2003.
Application No. 10/460,886 is a continuation-in-part of application No. 09/657,421, filed on Sep. 8, 2000, now Pat. No. 6,626,180.
Application No. 09/657,421 is a continuation-in-part of application No. 12/484,223, filed on Jun. 14, 2009.
(60) Provisional application No. 60/959,447, filed on Jul. 13, 2007.
(60) Provisional application No. 61/101,411, filed on Sep. 30, 2008.
(60) Provisional application No. 61/132,588, filed on Jun. 19, 2008.

(51) Int. Cl. A61C 5/14

(52) U.S. Cl. 128/861

(57) ABSTRACT

Oral apparatus 60 and methods for the reduction of cortisol levels due to psychological stress are disclosed. The oral apparatus 60 include at least a first bite pad 62 and a second bite pad 64 configured to be positioned between at least one of the molars of a user to relieve pressure at the temporomandibular joint or to withdraw the mandibular condyle from the articular fossa of the temporomandibular joint. The oral apparatus 60 is configured and the methods designed to downregulate the levels of cortisol in a user.

### CROSS REFERENCE TO RELATED APPLICATIONS

The present application claims benefit and priority of as a continuation of a patent application filed under the Patent Cooperation Treaty having Int'l Appl. No. PCT/US2008/070020 filed on Jul. 14, 2008, which claims the benefit and priority to U.S. Prov. Pat. Appl. No. 60/959,447 each of which is hereby incorporated by reference into the present disclosure.

The present application claims benefit and priority as a continuation-in-part of co-pending U.S. patent application Ser. No. 12/571,184, filed on Sep. 30, 2009, which claims benefit and priority to U.S. Prov. Pat. Appl. No. 61/101,411, filed on Sep. 30, 2008 each of which is hereby incorporated by reference into the present disclosure.

The present application also claims benefit and priority as a continuation-in-part of co-pending U.S. patent application Ser. No. 10/460,886, filed on Jun. 12, 2003 and now published as U.S. Pat. Pub. No. 2004/0250817, which is a continuation-in-part of U.S. patent application Ser. No. 09/657,421, filed on Sep. 8, 2000 and now issued as U.S. Pat. No. 6,626,180 each of which is hereby incorporated by reference into the present disclosure.

The present application also claims benefit and priority as a continuation-in-part of co-pending U.S. patent application Ser. No. 12/484,216, filed on Aug. 26, 2009, which is both a continuation of a patent application filed under the Patent Cooperation Treaty having Int'l Appl. No. PCT/US2009/047295, filed on Jun. 14, 2009, which claims the benefit and priority of U.S. Prov. Pat. App. Ser. No. 61/132,588, filed on Jun. 19, 2008, and is a continuation-in-part of U.S. patent application Ser. No. 10/460,886, filed on Jun. 12, 2003 and now published as U.S. Pat. Pub. No. 2004/0250817, which is a continuation-in-part of U.S. patent application Ser. No. 09/657,421, filed on Sep. 8, 2000 and now issued as U.S. Pat. No. 6,626,180 each of which is hereby incorporated by reference into the present disclosure.

The present application also claims benefit and priority as a continuation-in-part of co-pending U.S. patent application Ser. No. 12/484,223, filed on Jun. 14, 2009 and claiming benefit and priority from U.S. Prov. Pat. App. No. 61/132,590 filed Jun. 19, 2008 and now Published as U.S. Pat. Pub. No. 2009/0308403, which is a continuation in part of co-pending U.S. patent application Ser. No. 10/460,886, filed on Jun. 12, 2003 and is now published as U.S. Pat. Pub. No. 2004/0250817, which is a continuation-in-part of U.S. patent application Ser. No. 09/657,421, filed on Sep. 8, 2000 and now issued as U.S. Pat. No. 6,626,180 each of which is hereby incorporated by reference into the present disclosure.

### BACKGROUND OF THE INVENTIONS

1. Summary of the Inventions

The present inventions relate to medical devices and methods and, more particularly, to apparatus and methods for regulating cortisol levels in an individual.

2. Description of the Related Art

Cortisol, also called hydrocortisol, is secreted by the adrenal glands, which are situated atop each kidney. The adrenal cortex then secretes more than thirty (30) different steroid hormones called corticosteroids, with cortisol being the major corticosteroid. Cortisol plays an important role in regulating blood sugar, energy production, inflammation, the immune system, and healing. If cortisol levels are abnormally high, there are tendencies toward abnormal weight gain, especially around the abdomen, depressed immune function, accelerated aging, and stomach ulcers, among other problems.

Cortisol is elevated in response to stress. The stress can be physical, environmental, chemical, or imaginary. The human brain is hard wired with automatic responses to protect the body from harm. The classic work on stress was done by Dr. Hans Selye, M.D. He studied the physiological consequences of stress in rats and transferred that research data into a human model. As a consequence of our existence, all individuals must deal with stress created by not only extraordinary circumstances but also by our daily routines. These include environmental stress (heat, cold and noise, etc.), chemical stress (pollution, drugs, etc.), physical stress (overexertion, trauma, infection, etc.), psychological stress (worry, fear, etc.), and biochemical stress (nutritional deficiencies, refined sugar consumption, etc.). All of these different sources of stress may additive and cumulative in their effects on an individuals cortisol levels. All forms of stress typically produce similar physiological consequences.

In response to stress, the human body may go through three phases of response. The first phase may be characterized as reaction. In the reaction phase, the body experiences the symptoms from the trauma, infection, heat, cold, chemical irritation, etc. The endocrine system responds with the release of cortisol and other hormones to compensate for the trauma. The heart beats faster, the blood pressure rises, and the pupils dilate. The second phase may be characterized as adaptation. The adaptation phase may occur after the adrenal glands have enlarged and released large quantities of adrenal cortical hormones. In the adaptation phase, the symptoms may disappear and the individual may feel good, have energy, and be able to function in the presence of the source(s) of his/her stress. One of the consequences of this adaptation is suppression of the immune system. These individuals are more susceptible to infections, colds, and allergies, etc. The third phase may be characterized as the exhaustion phase. The exhaustion phase may occur after an extended period of the adaptation phase. In the exhaustion phase, the individuals' reserves of nutritional elements (raw materials) and resilience become depleted. The symptoms of the reaction phase may return. The individual may collapse physically, suffer a nervous breakdown, become dysfunctional, and/or experience an organ or body system failure (heart attack, stroke, etc.). In the most severe situations, the individual may die. Accordingly, a need exists for an apparatus and methods for assisting that may reduce the production of Cortisol.

The physiological actions of cortisol are to affect energy metabolism and to protect the body from stress. In the case of proteins and fats, cortisol degrades and increases delivery of amino acids and free fatty acids and glycerol. For carbohydrates, cortisol inhibits glucose uptake in tissues such as muscle and fat thereby making glucose available for nervous tissues. In addition, cortisol has many other necessary roles, which include mobilizing the body's defenses against infection, stimulating immune function, and improving cardiovascular efficiency. With all of its important roles, cortisol is considered to be one of the few hormones necessary for proper physiological functioning.

Although cortisol's physiological responses are vital to the maintenance of homeostasis within the body, elevated cortisol levels, either through medication or the body's excess production of the hormone, have been linked to negative health consequences. Such symptoms of excess cortisol include weight gain, abnormal accumulation of fat, high blood pressure, thinning bones, weak muscles, increased risk of infections, and emotional problems including mood swings, depression, and confusion. In addition, research has shown that exposing infants to high cortisol levels in mothers during birth is linked to reduced birth weight and increased risk of higher blood pressure later in life.

Physical symptoms associated with long term elevated cortisol levels can best be understood by studying the pathophysiology of Cushing's syndrome, a hormonal disorder resulting from excessive cortisol secretion. Generally, Cushing's syndrome can be caused by long-term use of glucocorticoid hormones in medications, which are used to treat inflammatory conditions such as arthritis and lupus. Another more rare form of Cushing's syndrome, called Cushing's disease, is caused by the body producing too much cortisol. The excess cortisol due to Cushing's syndrome can result negative physiological changes such as increased body fat, decreased bone density, and hypertension among others. One significant physical symptom associated with excessive elevated levels of cortisol is marked total body and skeletal muscle wasting.

Not only have physical symptoms been linked to excessive cortisol, but elevated cortisol levels have been linked to cognitive and mood dysfunction. It has been identified that patients with Cushing's syndrome exhibited deficits in cognitive impairment and declarative memory, respectively, with declarative memory being measured by the ability to recall content within a read paragraph or recall a word list. In a study of patient's having Cushing's syndrome, researchers found that patients had significantly lower IQ scores in four of five verbal subtests. In addition, they found that as levels of Cortisol secretion increased, verbal performance decreased in consequent fashion. Although these physical and mental symptoms are extreme, researchers hypothesize that even slightly higher elevations of cortisol may be linked to symptoms similar to those of Cushing's syndrome. Researchers, in studying elevated cortisol levels in depressed patients, have found similar physiological changes to those of Cushing's syndrome. For example, studies have shown increased body fat, decreased bone density and hypertension in depressed patients with elevated cortisol levels. In one study, it was found that among 230 depressed subjects that there was a positive correlation between elevated Cortisol levels and high blood pressure. Another study found significantly greater levels of cortisol urinary secretion to be highly correlated with reduced bone density in the spine and femoral neck of women with a depressive disorder. In addition, studies have correlated a high waist to hip ratio of subjects with a significantly higher secretion of cortisol.

The mechanism by which elevated cortisol levels may result in these adverse physiological consequences could vary due to the complex effects of cortisol within the body. In depressed patients, elevated levels of catecholamines, which have been linked to elevated cortisol, could result in hypertension. Bone density loss may be due to elevated cortisol, which decreases bone mineral metabolism such as inhibiting synthesis of collagen and absorption of calcium. While increased body fat and obesity may be due to cortisol's negative effects on serotonin levels. Finally, muscle atrophy as a result of increased cortisol has been linked to decreased rates of protein synthesis and increased amino acids.

Although cortisol is a necessary hormone to maintain physiological homeostasis, numerous studies have cited the negative effects of elevated and excessive cortisol levels on such things as cognitive function, depression and mood, bone loss, hypertension, and muscle atrophy. Even slight, short-term increases in cortisol can cause physiological changes that affect normal function such as elevated blood pressure, glycogen breakdown and increased blood sugar. Thus, lowering elevated cortisol levels may maintain the needed homeostasis and, thereby, combat any negative physiological consequences associated with stress. Accordingly, a need exists for methods and apparatus that may reduce the short term increases in cortisol levels.

### SUMMARY OF THE INVENTIONS

Apparatus and methods in accordance with the present invention may resolve many of the needs and shortcomings discussed above and will provide additional improvements and advantages as will be recognized by those skilled in the art upon review of the present disclosure.

The present invention provides methods and apparatus for reducing the increase in cortisol level in the human body's response to stress without the use of pharmaceuticals. The methods and apparatus may be used to provide substantial reductions in cortisol levels for non-athletic/non-exercise stress inducing events, such as office work, daily driving, testing, dieting, child care, arguing, general anxiety and the like or pain, noise, cold and the like. Additional non-athletic/non-exercise stress inducing events will be recognized by those skilled in the art upon review of the present disclosure. The present inventions provide for methods for reducing cortisol levels, inhibiting the increase of cortisol levels or otherwise downregulating the normal increase in cortisol levels in response to stress and/or normal daily activities by using an oral apparatus. The apparatus may be worn during a stress inducing event or activity, may be worn throughout the day or may be worn periodically throughout the day to manage the production of cortisol.

In an exemplary usage, a user positions an oral apparatus in his or her mouth in anticipation of, during or after entering into a stressful activity. The oral apparatus includes at least first bite pad and a second bite pad generally configured to reduce or eliminate the accumulation of pressure at the temporomandibular joint as a user clenches his or her teeth and/or to reduce the pressure on the joint during normal daily activities of the user. The first bite pad and the second bite pad are typically positioned on opposite sides of the user's mouth between at least two of the molars of a user. When at least the molars of the user exert an opposing pressure on the first bite pad and the second bite pad, the lower mandible is positioned to reduce the pressure at the temporomandibular joint relative to the pressures generated when a user is not wearing an oral apparatus. By reducing the pressure on the temporomandibular joint, a user may reduce the increase in cortisol levels arising from the human body's response to daily activities and/or stress.

Oral apparatus in accordance with aspects of the present inventions may position the lower mandible in one of various positions to reduce the increase in cortisol the human body's response to daily activities and/or stress. In one aspect, the pressure of at least the molars on the oral apparatus positions the lower mandible to generally reduce the pressure at the temporomandibular joint an amount effective to downregulate the levels of cortisol in the user. In another aspect, the pressure of at least the molars on the oral apparatus positions the lower mandible to reduce the pressure at the temporomandibular joint an amount sufficient to reduce the levels of cortisol in the user. In yet another aspect, the pressure of at least the molars on the oral apparatus positions the lower mandible to inhibit an increase in cortisol levels in the user. In another aspect, the pressure of at least the molars on the oral apparatus positions the mandibular condyles downward relative to the articular fossae at the temporomandibular joints a distance effective to regulate the levels of cortisol in the user. In another aspect, the pressure of at least the molars on the oral apparatus positions the mandibular condyles downward relative to the articular fossae at the temporomandibular joints a distance effective to reduce the levels of cortisol in the user. In yet another aspect, the pressure of at least the molars on the oral apparatus repositions the mandibular condyles downward relative to the articular fossae at the temporomandibular joints a distance effective to inhibit an increase in cortisol levels in the user. In another aspect, the pressure the pressure of at least the molars on the oral apparatus positions the mandibular condyles downward and forward relative to the articular fossae at the temporomandibular joints a distance effective to regulate the levels of cortisol in the user. In another aspect, the pressure the pressure of at least the molars on the oral apparatus positions the mandibular condyles downward and forward relative to the articular fossae at the temporomandibular joints a distance effective to reduce the levels of cortisol in the user. In yet another aspect, the pressure the pressure of at least the molars on the oral apparatus positions the mandibular condyles downward and forward relative to the articular fossae at the temporomandibular joints a distance effective to inhibit an increase in cortisol levels in the user. Other features and advantages of the invention will become apparent from the following detailed description, and from the claims.

### BRIEF DESCRIPTION OF THE FIGURES

FIGS. 1A and 1B illustrate the repositioning of a lower mandible with an exemplary oral apparatus to relieve pressure at the temporomandibular join in accordance with aspects of the present inventions;

FIG. 2A illustrates another exemplary apparatus in accordance with aspects of the present inventions;

FIG. 2B illustrates the apparatus of FIG. 2A positioned in an exemplary manner to the lower mandible of a user;

FIG. 3A illustrates yet another exemplary apparatus in accordance with aspects of the present inventions;

FIG. 3B illustrates the apparatus of FIG. 3A positioned in an exemplary manner on the maxilla of a user;

FIG. 4A illustrates yet another exemplary apparatus in accordance with aspects of the present inventions;

FIG. 4B illustrates the apparatus of FIG. 4A positioned in an exemplary manner on the maxilla of a user;

FIG. 5A illustrates yet another exemplary apparatus in accordance with aspects of the present inventions;

FIG. 5B illustrates the apparatus of FIG. 5A positioned in an exemplary manner to the lower mandible of a user;

FIG. 6A illustrates yet another exemplary apparatus in accordance with aspects of the present inventions;

FIG. 6B illustrates the apparatus of FIG. 6A positioned in an exemplary manner on the maxilla of a user;

FIG. 7 illustrates yet another exemplary apparatus in accordance with aspects of the present inventions;

FIG. 8 is a graph showing the average basal levels of cortisol and average increase in cortisol levels both with and without using an oral apparatus in accordance with aspects of the present inventions; and

FIG. 9 is a graph showing variations in cortisol levels of eleven individuals each tested both with and without an oral apparatus.

All Figures are illustrated for ease of explanation of the basic teachings of the present invention only; the extensions of the Figures with respect to number, position, relationship and dimensions of the parts to form the embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in various Figures of the drawings, the same numerals designate the same or similar parts. Furthermore, when the terms “top,” “bottom,” “right,” “left,” “forward,” “rear,” “first,” “second,” “inside,” “outside,” and similar terms are used, the terms should be understood to reference only the structure shown in the drawings and utilized only to facilitate describing the illustrated embodiments. Similarly, when the terms “proximal,” “distal,” and similar positional terms are used, the terms should be understood to reference the structures shown in the drawings as they will typically be utilized by one skilled in the art.

### DETAILED DESCRIPTION OF THE INVENTIONS

The present inventions provide methods and oral apparatus 60 for reducing the increase cortisol levels typically associated with mental stress. In one aspect, the methods may be utilized non-athletic stress inducing activities. The figures generally illustrate embodiments of oral apparatus 60 for use in methods in accordance with the present inventions and the results from the testing on the methods affect on cortisol levels. The particular exemplary embodiments of the oral apparatus 60 illustrated in the figures have been chosen for ease of explanation and understanding of the implementation of various aspects of the present inventions. These illustrated embodiments are not meant to limit the scope of coverage but instead to assist in understanding the context of the language used in this specification and the appended claims. Accordingly, variations of oral apparatus 60 for use reducing cortisol levels different from the illustrated embodiments may be encompassed by the appended claims.

Various exemplary embodiments of oral apparatus 60 in accordance with aspects of the present invention are illustrated throughout the figures for exemplary purposes. The illustrated oral apparatus 60 include at least a first bite pad 62 and a second bite pad 64. The oral apparatus 60 may be secured over one or both of the upper and lower teeth. The first bite pad 62 and the second bite pad 64 are generally configured to position the lower mandible 42 relative to the maxilla 12 in a manner that relieves pressure at the temporomandibular joint 32. The first bite pad 62 and the second bite pad 64 are typically configured to be received between the occlusal surfaces of the upper (palatal) and lower (lingual) rows of teeth. Particularly, at least a portion of the first bite pad 62 and at least a portion of the second bite pad 64 are configured to be received between at least two molars. The first bite pad 62 and the second bite pad 64 are generally sized to be received between the occlusal surfaces of at least two teeth (one upper and one lower). In one aspect, the first bite pad 62 and the second bite pad 64 may have dimensions of about 5/16 inches wide and 1⅛ inches long. When positioned between the occlusal surfaces of the upper and lower teeth, the first bite pad 62 and the second bite pad 64 are typically configured to space the upper and lower molars apart by 0.5 millimeters and 4.5 millimeters at the posterior edge of each of the bite pads. In certain aspects, the first bite pad 62 and the second bite pad 64 are typically configured to space the upper and lower molars apart by 1.00 millimeters and 4.00 millimeters at the posterior edge of each of the bite pads. In one particular embodiment, the first bite pad 62 and the second bite pad 64 are typically configured to space the upper and lower molars apart by 2.0 millimeters at the posterior edge of each of the bite pads. The first bite pad 62 and the second bite pad 64 may have a uniform thickness from anterior edge to posterior edge and medial edge to lateral edge. The first bite pad 62 and the second bite pad 64 may also have a variable thickness between one or more of the anterior edge to posterior edge and medial edge to lateral edge. In one aspect, the first bite pad 62 and the second bite pad 64 have one or more of a planar upper surface and a planar lower surface. In one aspect of a variable thickness, the first bite pad 62 and the second bite pad 64 may be configured to space the upper and lower teeth apart by 0.0 millimeters and 4.5 millimeters at the anterior edge of each of the bite pads. In certain aspects, the first bite pad 62 and the second bite pad 64 are configured to space the upper and lower teeth apart by 0.2 millimeters and 2.00 millimeters at the anterior edge of each of the bite pads. In one particular embodiment, the first bite pad 62 and the second bite pad 64 are typically configured to space the upper and lower teeth apart by 1.0 millimeters at the anterior edge of each of the bite pads. When of the anterior edge and the posterior edge of the first bite pad 62 and the second bite pad 64 are of different thicknesses, the first bite pad 62 and the second bite pad 64 may have the shape, in profile, of a wedge (thicker in front and thinner in rear) or a reverse wedge (thinner in front and thicker in rear).

In one theory of operation, it is believed that the oral apparatus 60 may alter the central nervous system's afferent input by relieving pressure at the temporomandibular joint. either through periodontal ligament or temporomandibular joint pathways, ultimately affecting the hypothalamic-pituitary-adrenal (HPA) axis, altering neurochemical pathways involving corticotrophin releasing factor (CRF) and ultimately cortisol.

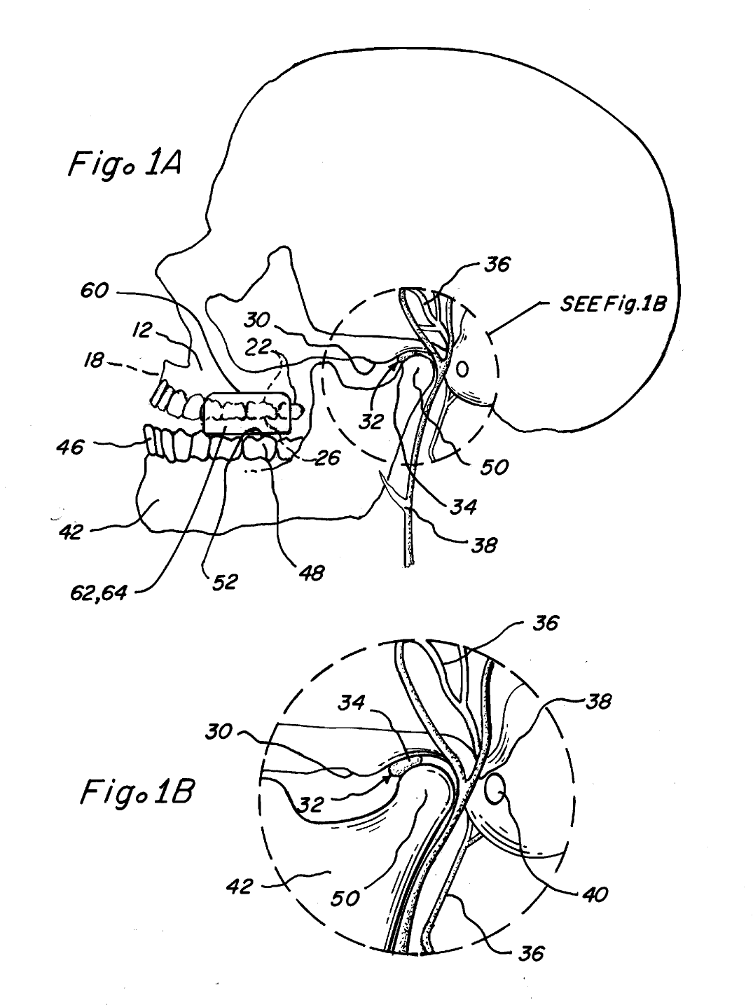

FIGS. 1A and 1B, show an oral apparatus 60 positioned within the skull of a user. The lower mandible 42 articulates with the skull at the temporomandibular joint 32. The maxilla 12 supports upper anterior teeth (incisors and canines) 18 and upper posterior teeth (molars and bicuspids) 22 which have cusps and occlusal surfaces 26. The lower mandible 42 supports the lower anterior teeth (incisors and canines) 46 and lower posterior teeth (molars and bicuspids) 48 with occlusal surfaces 52. The mandibular condyles 50 of the lower mandible 42 are received within the articular fossae 30 with each side supported and cushion by a meniscus 34 to form the temporomandibular joint 32. When the mouth opens, two distinct motions typically occur at the temporomandibular joint 32. The first motion is rotation around a horizontal axis through the heads of mandibular condyle 50. The second motion is translation. When the mouth is fully open, the mandibular condyle 50 may lie beneath the anterior band of the meniscus 34. The mandibular condyle 50 and meniscus 34 both move together anteriorly beneath the articular eminence 30. In the closed position, the thick posterior band of the meniscus 34 lies immediately above the mandibular condyle 50. As the mandibular condyle 50 translates forward, the thinner intermediate zone of the meniscus 34 becomes the articulating surface between the mandibular condyle 50 and the articular eminence 30.

The first bite pad 62 and the second bite pad 64 of oral apparatus 60 in accordance with aspects of the present inventions is typically positioned between at least the upper molars and/or bicuspids 22 and the lower molars and/or bicuspids 48 to prevent excessive pressure, reduce pressure or to eliminate pressure at the temporomandibular joint 32 as the lower mandible 42 is drawn toward the maxilla 12 primarily by the masseter muscle. In certain aspects, the oral apparatus 60 may withdraw the mandibular condyle 50 downward from the articular fossa 30 in response to an attempt by a user to clench their teeth. In other aspects, the oral apparatus 60 may withdraw the mandibular condyle 50 downward and forward from the articular fossa 30 in response to an attempt by a user to clench their teeth. Such movement may relieve or create pressure on a number of vessels in the area of the temporomandibular joint 32. Particularly, the auriculo-temporalis nerve 36 and the supra-temporal artery pass posterior to the temporomandibular joint 32. The auriculo-temporalis nerve 36 functions in both sensory and motor activities of the body. The supra-temporal artery 38 provides blood circulation to the head. Impingement, pinching, rupture or blockage of the supra-temporal artery 38 may restrict blood flow to the brain. Additional nerve and vessels are also in close proximity to the temporomandibular joint and may be affected by a repositioning of the lower mandible 42.

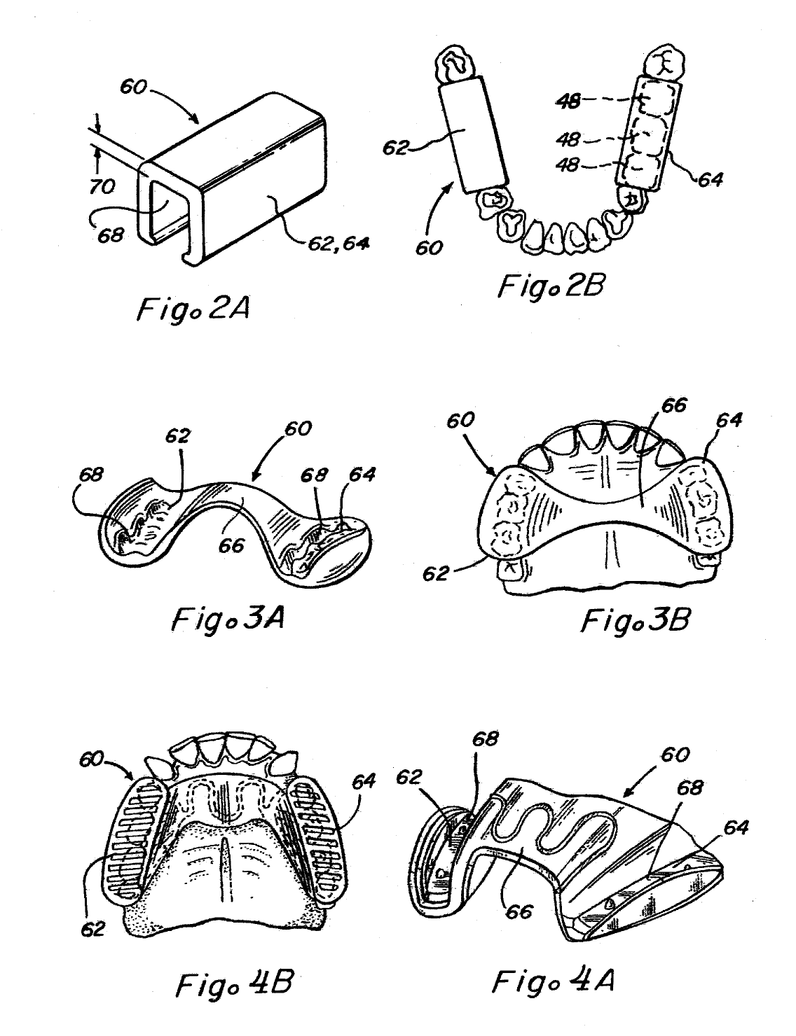

FIGS. 2A and 2B illustrate an exemplary embodiment for an oral apparatus 60 in accordance with aspects of the present inventions. The illustrated oral apparatus 60 includes a first bite pad 62 and a second bite pad 64. Each of the first bite pad 62 and the second bite pad 64 of the illustrated embodiment are configured to be received between at least one of the upper teeth and at least one of the lower teeth of a user. The first bite pad 62 and the second bite pad 64 may be configured to be received over at least one of the upper or lower teeth of a user. The first bite pad 62 and the second bite pad 64 each define a channel 68 to receive the teeth of the user. As particularly illustrated, the first bite pad 62 and the second bite pad 64 are configured to be received over the lower molar 48. Further, the first bite pad 62 and the second bite pad 64 may be configured to be secured to one of the upper or the lower teeth of a user to retain the first bite pad 62 and the second bite pad 64 at the desired location. A thickness 70, size and shape of the portion of each bite pad 62, 64 received between the teeth of the user determines how the lower mandible 42 will be positioned when a user clenches his/her teeth as will be recognized by those skilled in the art upon review of the present disclosure.

FIGS. 3A and 3B illustrate another exemplary embodiment for an oral apparatus 60 in accordance with aspects of the present inventions. Similar oral apparatus 60 are disclosed in U.S. Pat. No. 6,553,996 the disclosure of which is hereby incorporated by reference in its entirety. The illustrated oral apparatus 60 includes a first bite pad 62 and a second bite pad 64 secured to one another by an interconnect 66 configured to be positioned adjacent to the roof of a user's mouth. The exemplary interconnect 66 is configured to extend across a substantially central portion of the roof of the user's mouth. Each of the first bite pad 62 and the second bite pad 64 of the illustrated embodiment are configured to be received between at least one of the upper teeth and at least one of the lower teeth of a user. The first bite pad 62 and the second bite pad 64 of the illustrated embodiment may be configured to be received over at least one of the upper or lower teeth of a user. The first bite pad 62 and the second bite pad 64 each define a channel 68 to receive the teeth of the user. As particularly illustrated, the first bite pad 62 and the second bite pad 64 are configured receive the anterior two upper molars 22 on each side of a users mouth and the bicuspids 22 of the user. The channels 68 of each of the first bite pad 62 and the second bite pad 64 have been shaped to conform to the molars 22, 48 of a user. A thickness, size and shape of the portion of each bite pad 62, 64 received between the teeth of the user determines how the lower mandible 42 will be positioned when a user clenches his/her teeth as will be recognized by those skilled in the art upon review of the present disclosure.

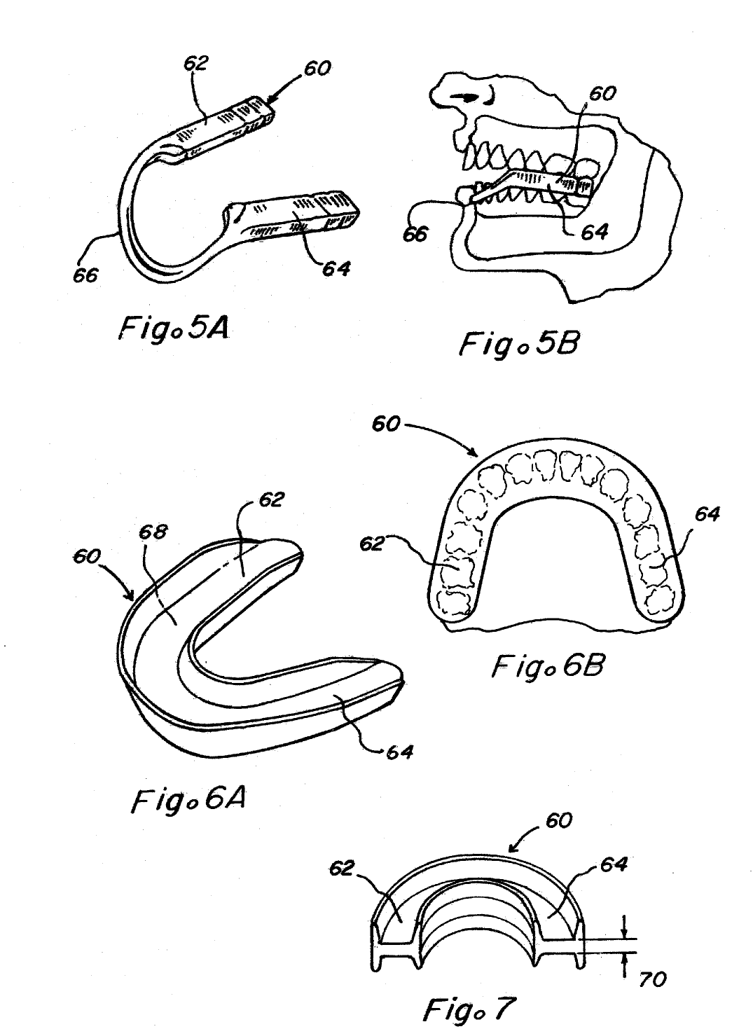

FIGS. 4A and 4B illustrate another exemplary embodiment for an oral apparatus 60 in accordance with aspects of the present inventions. Similar oral apparatus 60 are disclosed in U.S. Pat. No. 6,415,794 the disclosure of which is hereby incorporated by reference in its entirety. The illustrated oral apparatus 60 includes a first bite pad 62 and a second bite pad 64 secured to one another by an interconnect 66 configured to be positioned adjacent to an anterior portion of the roof of a user's mouth. Each of the first bite pad 62 and the second bite pad 64 of the illustrated embodiment are configured to be received between at least one of the upper teeth and at least one of the lower teeth of a user. The first bite pad 62 and the second bite pad 64 of the illustrated embodiment may be configured to be received over at least one of the upper or lower teeth of a user. The first bite pad 62 and the second bite pad 64 each define a channel 68 to receive the teeth of the user. As particularly illustrated, the first bite pad 62 and the second bite pad 64 are configured receive the all of the upper molars 22 and the upper bicuspids 22 of a user. The channels 68 of each of the first bite pad 62 and the second bite pad 64 may be sized to securely receive the molars 22, 48 of a user. A thickness 70, size and shape of the portion of each bite pad 62, 64 received between the teeth of the user determines how the lower mandible 42 will be positioned when a user clenches his/her teeth as will be recognized by those skilled in the art upon review of the present disclosure.

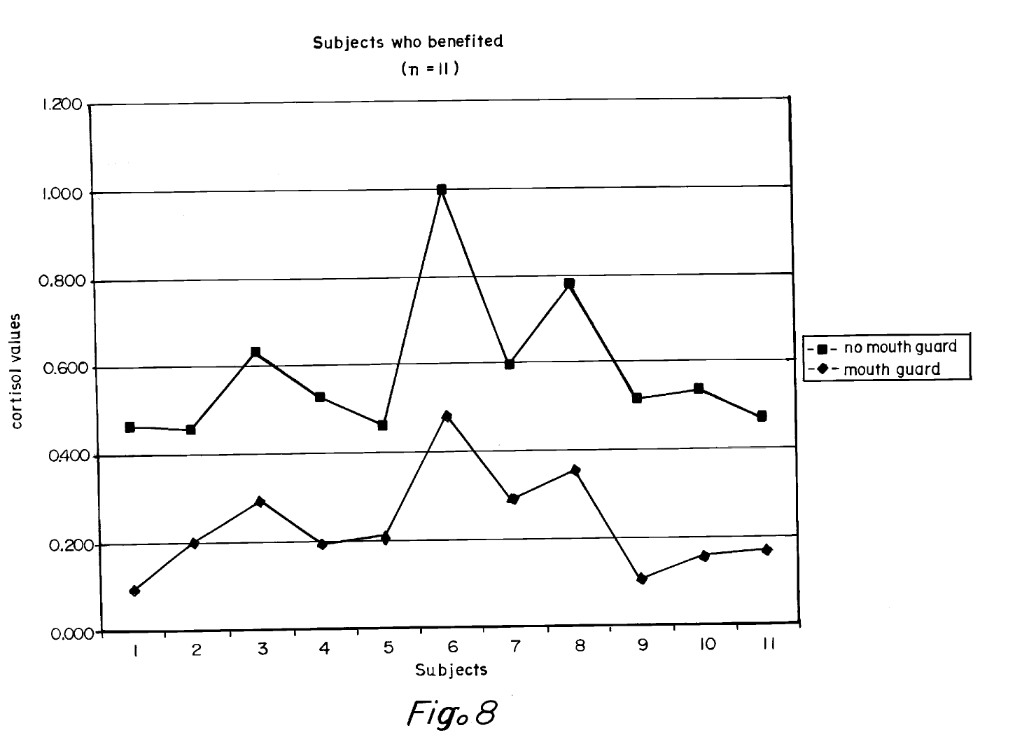

FIGS. 5A and 5B illustrate another exemplary embodiment for an oral apparatus 60 in accordance with aspects of the present inventions. Similar oral apparatus 60 are disclosed in U.S. Pat. No. 6,371,758 the disclosure of which is hereby incorporated by reference in its entirety. The illustrated oral apparatus 60 includes a first bite pad 62 and a second bite pad 64 secured to one another by an interconnect 66 configured to be positioned between the lower lip and the lower teeth and/or gums of a user. The first bite pad 62 and the second bite pad 64 may be configured to be received between the upper or lower teeth 22, 48 of a user. The first bite pad 62 and the second bite pad 64 each define an upper and a lower surface. The upper surface configured to contact the upper teeth 22 of the user. The lower surface configured to contact the lower teeth 48 of the user. As particularly illustrated, the first bite pad 62 and the second bite pad 64 are configured contact the all of the upper molars 22 and upper bicuspids 22 and the lower molars 48 and lower bicuspids 48. A thickness 70, size and shape of each bite pad 62, 64 and the associated shape of the upper and lower surfaces where received between the teeth of the user determines how the lower mandible 42 will be positioned when a user clenches his/her teeth as will be recognized by those skilled in the art upon review of the present disclosure.

FIGS. 6A and 6B illustrate another exemplary embodiment for an oral apparatus 60 in accordance with aspects of the present inventions. Similar oral apparatus 60 are disclosed in U.S. Pat. No. 6,691,710 the disclosure of which is hereby incorporated by reference in its entirety. The illustrated oral apparatus 60 includes a first bite pad 62 and a second bite pad 64 secured to one another by an interconnect 66 configured to be positioned over the incisors and canines of a user. Each of the first bite pad 62 and the second bite pad 64 may be configured to be received between the upper or lower teeth of a user. The first bite pad 62 and the second bite pad 64 define a channel 68 which is continuous through the interconnect 66 to receive the teeth of the user. As particularly illustrated, channel 68 extends through the first bite pad 62, the interconnect 66, and the second bite pad 64 receive all of the upper teeth of a user. The channel 68 has been sized to receive the upper teeth of the user and may be configured to securely hold the teeth of the user. A thickness 70, size and shape of the portion of each bite pad 62, 64 received between the teeth of the user determines how the lower mandible 42 will be positioned when a user clenches his/her teeth as will be recognized by those skilled in the art upon review of the present disclosure.

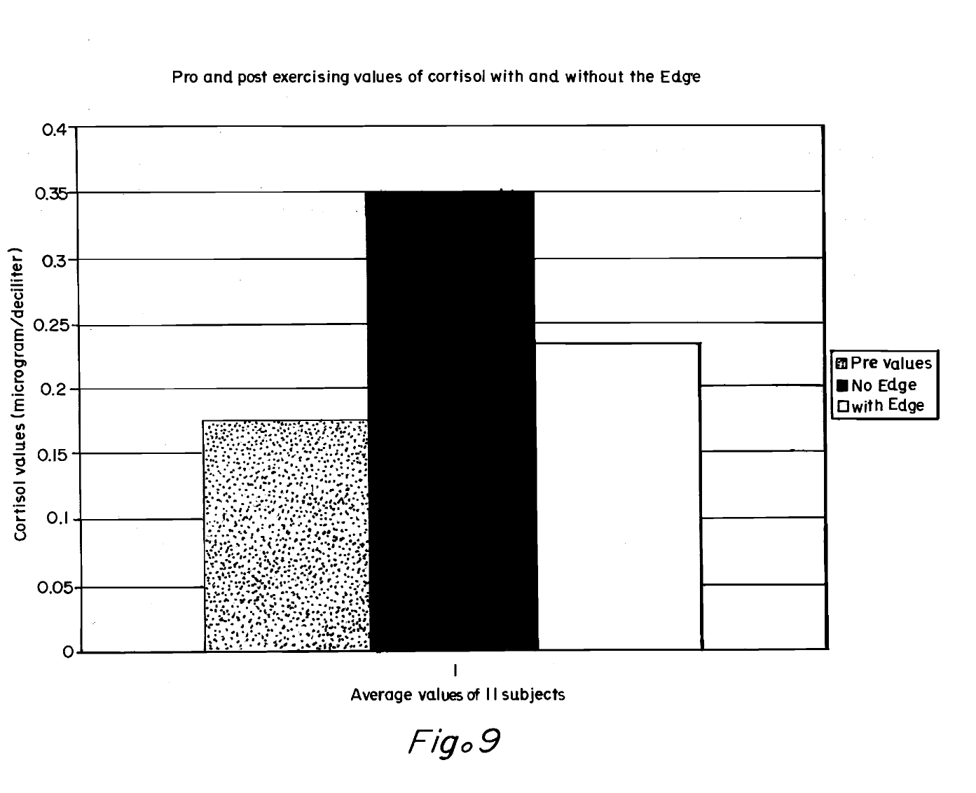

FIG. 7 illustrate another exemplary embodiment for an oral apparatus 60 in accordance with aspects of the present inventions. The illustrated oral apparatus 60 includes a first bite pad 62 and a second bite pad 64 secured to one another by an interconnect 66 configured to be positioned over the incisors and canines of a user. Each of the first bite pad 62 and the second bite pad 64 of the illustrated embodiment are configured to be received between at least one of the upper teeth and at least one of the lower teeth of a user. The first bite pad 62 and the second bite pad 64 define a channel 68 and a lower channel 69. Each of the channel 68 and the lower channel 69 is shown as continuously extending through the interconnect 66. The channel 68 is configured to receive the upper teeth of the user. The lower channel 69 is configured to receive the lower teeth of the user. As particularly illustrated, each of channel 68 and lower channel 69 extends through all of the first bite pad 62, the interconnect 66, and the second bite pad 64 receive all of the teeth of a user. Each of the channel 68 and lower channel 69 has been sized to receive the teeth of the user and at least one of the channel 68 and the lower channel 69 may be configured to securely hold the teeth of the user. A thickness 70, size and shape of the portion of each bite pad 62, 64 received between the teeth of the user determines how the lower mandible 42 will be positioned when a user clenches his/her teeth as will be recognized by those skilled in the art upon review of the present disclosure.

In use, a first bite pad 62 and a second bite pad 64 of an oral apparatus 60 is positioned between the occlusal surfaces of the upper and lower teeth on both the left and right side of the user's mouth. The bite pads 62, 64 are positioned between at least two molars (one upper and one lower) on each side of the user's mouth. The bite pads 62, 64, in various other embodiments, may extend between at least the second premolar and first molar, may extend between at least the second premolar and second molar, may extend between at least the first premolar and second molar and may extend between at least the canines and the third molar. The bite pads 62, 64 are configured to generally reduce and/or eliminate pressure between the mandibular condyle 50 articular fossa at the temporomandibular joint as the teeth of the user are clenched. The apparatus and methods of the present invention have been shown to position the lower mandible in a position effective to inhibit an increase in cortisol levels or otherwise downregulate cortisol levels in response to stress. In accordance with aspects of the present inventions, the oral apparatus 60 may be used be in the treatment of psychologically, environmentally, physiological (such as those associated with various disorders and those not associated with physical exertion) or otherwise induced increases in cortisol that are not primarily a result of physical exertion herein collectively referred to as non-athletically induced increases in cortisol. For purposes of the present disclosure, increases in cortisol not primarily a result of physical exertion will be termed non-athletic. The oral apparatus 60 may in certain aspects be positioned in the mouth prior to or in anticipation of a non-athletic stress inducing event to reduce an associated increase in cortisol levels. In other aspects, the oral apparatus 60 may be positioned in the mouth of a user after or during a non-athletic stress inducing event to reduce an increase in cortisol levels. The oral apparatus 60 may be worn throughout the day and night or portions thereof to downregulate the overall daily production of cortisol due to non-athletic stress inducing events or to reduce the typical increase of cortisol levels throughout the day.

### Example 1

In one study, seventeen test subjects between the ages of eighteen and twenty four years old were recruited for an evaluation in the reduction of cortisol by an oral apparatus 60 (similar to that disclosed in U.S. Pat. No. 6,415,794 and that illustrated in FIG. 4B) in exercise-induced stress. The study utilized a stationary bike ergometer. The test subjects have salivary cortisol levels measured at three points: at rest before first exercise; after first exercise; and after second exercise. Saliva samples were obtained from the test subjects at each point for analysis of cortisol levels. The saliva samples were collected in straws and transferred to a cryovial. The samples were frozen and sent to Salimetrics, LLC in State College, Pa. for analysis using an enzyme immunoassay for salivary cortisol. Each test subject was exercised for 10 minutes on two separate days. Test subjects wear an oral apparatus 60 for one round of exercise but not for the other round. Test subjects have heart rate and blood pressure measured during exercise. Test subjects were exercised at a rate resulting in between about 85 to 90% of maximum heart rate. Test subjects were also asked to rate their level of fatigue or exertion during exercise. Individual and study population comparisons of variables were performed using standard statistical methodologies.

The results of the study are illustrated in the graphs of FIGS. 8 and 9. FIG. 8 illustrates the average for the population of the study and FIG. 9 illustrates the results for all of the individuals. Main comparisons are of baseline and post-exercise cortisol levels. The results illustrate the differences in post-exercise levels between exercise with an oral apparatus 60 and without an oral apparatus 60. In FIG. 8, the chart illustrates the results of the eleven (11) subjects who demonstrated a lowering of their cortisol values using the oral apparatus 60. In all of these cases, the cortisol was at least 50% lower using the oral apparatus 60. In FIG. 9, the chart illustrates the combined results of the 11 test subjects quantifying the pre-exercise cortisol level (Pre Values) in the shaded bar, the post-exercise cortisol level without an oral apparatus (No Edge) in the blackened bar, and the post-exercise cortisol level with an oral apparatus 60 (With Edge) in the white bar. The bar graph illustrates an increase in cortisol levels from about 0.175 microgram per deciliter for the Pre Values to about 0.23 microgram per deciliter No Edge or about a 0.06 microgram per deciliter increase from pre-exercise cortisol levels to the post-exercise cortisol level with an oral apparatus 60. The bar graph also illustrates an increase in cortisol levels from about 0.17 microgram per deciliter for the Pre Values to about 0.35 micrograms per deciliter With Edge or about a 0.18 microgram per deciliter increase from pre-exercise cortisol levels to the post-exercise cortisol level without an oral apparatus 60. These results show a statistically significant reduction in levels using an oral apparatus 60 during stress generated primarily by physical exertion.

### Example 2

In another study, nineteen graduate students, between the ages of 20-30 years old, were recruited to participate were recruited for an evaluation in the reduction of cortisol accumulation by an oral apparatus 60 (similar to that disclosed in U.S. Pat. No. 6,415,794 and that illustrated in FIG. 4B) in response to a non-athletically induced stress. Participants were asked to take a written essay exam in a course in which the participants were formally registered for academic credit. Ten of the students took the test with an oral apparatus 60 and nine of the students took the test with no oral apparatus 60. Five minutes before the test and 10 minutes after the test, subjects were asked to give a passive drool salivary sample by placing a straw in their mouth and allowing their saliva to drool down the straw into a cryovial. The sample was then be labeled and placed into a freezer until all samples are collected and ready for assay to detect differences in cortisol levels using an enzyme immunoassay for salivary cortisol. The samples were shipped to Salimetrics in College Station, Pennsylvania, as directed, to assay for cortisol levels.

The results of the study are expected to correlate to those illustrated in the graphs of FIGS. 8 and 9. Similarly, the main comparisons will be of baseline and post-testing cortisol levels. These results show a statistically significant reduction in levels using an oral apparatus 60 during non-athletically induced stress.

### Example 3

In a proposed study, number test subjects could be recruited for an evaluation in the reduction of cortisol by an oral apparatus 60 from psychologically induced stress arising out of the timed solving of one or more puzzles. The proposed study could utilize one or more standard puzzle based methodologies used for inducing stress. The test subjects could have salivary and/or serum cortisol levels measured at three points: at rest before the first puzzle; after the first puzzle; and after second puzzle. Saliva and/or blood samples could be obtained from the test subjects at each point for analysis of Cortisol levels using standard methodologies. The samples could be frozen and stored for later analysis. Each test subject will be tested during a predetermined time period on two separate days. Test subjects wear an oral apparatus 60 for one round of testing but not for the other round of testing. Test subjects could have heart rate and blood pressure could be measured during exercise. Test subjects may be asked one or more questions relating to their physical and/or psychological state during testing.

Individual and study population comparisons of variables could again be performed using standard statistical methodologies. The results of the study would be expected to correlate to those illustrated in the graphs of FIGS. 8 and 9. Similarly, the main comparisons could be of baseline and post-testing cortisol levels. These results would be expected to show a statistically significant reduction in levels using an oral apparatus 60 during non-athletically induced stress.

### Example 4

In another proposed study, number test subjects could be recruited for an evaluation in the reduction of cortisol by an oral apparatus 60 from psychologically induced stress arising out of a cold pressor test. The proposed study could utilize standard cold pressor test based methodologies for inducing pain originated stress. The test subjects could have salivary and/or serum cortisol levels measured at three points: at rest before the first cold pressor test; after the first cold pressor test; and after second cold pressor test. Saliva and/or blood samples could be obtained from the test subjects at each point for analysis of cortisol levels using standard methodologies. The samples could be frozen and stored for later analysis. Each test subject will be tested during a predetermined time period. Test subjects could wear an oral apparatus 60 for one round of testing but not for the other round of testing. Test subjects could also have heart rate and blood pressure may be measured during testing. Test subjects could be asked one or more questions relating to their physical and/or psychological state during testing.

Individual and study population comparisons of variables could again be performed using standard statistical methodologies. The results of the study would be expected to correlate to those illustrated in the graphs of FIGS. 8 and 9. Similarly, the main comparisons could be of baseline and post-testing cortisol levels. These results would be expected to show a statistically significant reduction in levels using an oral apparatus 60 during non-athletically induced stress.

### Example 5

In another proposed study, a statistically relevant number test subjects could be recruited for an evaluation in the reduction of cortisol by an oral apparatus 60 in individuals with chronically elevated levels of cortisol such as for example individuals with Cushing's syndrome or other conditions elevating cortisol levels. The test subjects could have salivary and/or serum cortisol levels measured at no less than two points: prior to the administration of a therapy using an oral apparatus 60 and after a therapy using an oral apparatus 60. Saliva and/or blood samples could be obtained from the test subjects at each point for analysis of cortisol levels using standard methodologies. The samples could be frozen and stored for later analysis. Each test subject could be tested for a predetermined time period on two separate days. Test subjects could wear an oral apparatus 60 for one round of testing but not for the other round of testing. Test subjects may also have heart rate and blood pressure may be measured at the time of sample collection. Test subjects may be asked one or more questions relating to their physical and/or psychological state prior to and during the therapy period.

Individual and study population comparisons of variables could again be performed using standard statistical methodologies. The results of the study would be expected to correlate to those illustrated in the graphs of FIGS. 8 and 9. Similarly, the main comparisons could be of baseline and post-testing cortisol levels. These results would be expected to show a statistically significant reduction in levels using an oral apparatus 60 during non-athletically induced stress.

### Example 6

In a proposed study, number test subjects could be recruited for an evaluation in the reduction of cortisol by an oral apparatus 60 from non-athletically induced stress arising out of standardized testing. The proposed study could utilize test subjects preparing for post-graduate entrance examinations take practice tests. A statistically relevant number of students taking a practice Medical College Admissions Test (MCAT), Law School Admissions Test (LSAT) or Graduate Records Examination (GRE) could for example be utilized. The test subjects could have salivary and/or serum cortisol levels measured at three or more points: a significant period of time before the test before preparation for testing; during preparation for testing; immediately before the test; and after the test. Saliva and/or blood samples could be obtained from the test subjects at each point for analysis of cortisol levels using standard methodologies. The samples could be frozen and stored for later analysis. Each test subject could be tested during a predetermined time period on two separate days. A statistically relevant number of test subjects could wear an oral apparatus 60 during testing. Another statistically relevant number of test subjects will not wear an oral apparatus 60 during testing. Test subjects could have heart rate and blood pressure measured during testing. Test subjects could be asked one or more questions relating to their physical and/or psychological state during testing to measuring subjective sense of stress or mental exertion for various individuals.

Individual and study population comparisons of variables could again be performed using standard statistical methodologies. The results of the study would be expected to correlate to those illustrated in the graphs of FIGS. 8 and 9. Similarly, the main comparisons could be of baseline before test preparation cortisol levels vs. immediately pre-testing and post-testing cortisol levels. These results would again be expected to show a statistically significant reduction in levels using an oral apparatus 60 during non-athletically induced stress.

The foregoing discussion discloses and describes merely exemplary embodiments of the present invention. Upon review of the specification, one skilled in the art will readily recognize from such discussion, and from the accompanying drawings and claims, that various applications, changes, modifications and variations can be made therein without departing from the spirit and scope of the invention as defined in the following claims.

What is claimed is:

1. A method for inhibiting cortisol accumulation, comprising:
positioning an oral apparatus having at least first bite pad and a second bite pad between at least the molars of a user; and
at least reducing the pressure at the temporomandibular joint as the user clenches reduce a normal increase in cortisol levels.

2. A method, as in claim 1, further comprising exposing the user to a stress arising from a non-athletic activity.

3. A method, as in claim 1, further comprising positioning a mandibular condyle downward relative to an articular fossa at the temporomandibular joint a distance effective to regulate the levels of cortisol in the user as the user clenches.

4. A method, as in claim 1, further comprising positioning a mandibular condyle downward relative to an articular fossa at the temporomandibular joint a distance effective to reduce the levels of cortisol in the user as the user clenches.

5. A method, as in claim 1, further comprising positioning a mandibular condyle downward relative to an articular fossa at the temporomandibular joint a distance effective to inhibit an increase in cortisol levels in the user as the user clenches.

6. A method, as in claim 1, further comprising positioning a mandibular condyle downward and forward relative to an articular fossa at the temporomandibular joint a distance effective to regulate the levels of cortisol in the user as the user clenches.

7. A method, as in claim 1, subjecting the user to a source of psychological stress.

8. A method, as in claim 1, further comprising positioning a mandibular condyle downward and forward relative to an articular fossa at the temporomandibular joint a distance effective to inhibit an increase in cortisol levels in the user as the user clenches.
